(19) United States
(12) Patent Application Publication
(10) Pub. No.: US 2009/0079187 A1
(43) Pub. Date: Mar. 26, 2009

(54) FLUIDIC COUPLING WITH DEFORMABLE QUICK CONNECTOR

(75) Inventor: David S. Malone, Attica, MI (US)

Correspondence Address: YOUNG & BASILE, P.C., 3001 WEST BIG BEAVER ROAD, SUITE 624, TROY, MI, 48084, US

(73) Assignees: ITT AUTOMOTIVE, INC., Auburn Hills, MI (US); BRASSCRAFT MANUFACTURING COMPANY, Novi, MI (US)

(21) Appl. No.: 11/860,578

(22) Filed: Sep. 25, 2007

(51) Int. Cl. F16L 37/00

(52) U.S. Cl. 285/305

(57) ABSTRACT

A quick connector body includes a bore fluidically coupled to a bore extending from an open end of an endform when the body is mounted on the endform. Cooperating, initially spaced, latch members and latch engagement members are unitarily carried on the connector body. A collapsible portion is formed on the body between the latch members and the latch engagement members for radial inward protrusion into an annular groove in the endform substantially concurrent with engagement of the latch members and the latch engagement members to fixedly couple the connector on the endform. In one aspect a second end of the connector body is closed to form the connector body as a test cap. In another aspect, a second end of the connector body is open to establish a fluid flow path from the endform to a fluid component coupled to the second end of the connector body.

### BACKGROUND OF THE INVENTION

The present invention relates, in general, to fluid couplings used to fluidically couple one or more fluid components and, more specifically, to test caps used in building plumbing for system pressure tests.

In plumbing, copper pipes are mounted within the building walls, floor, and/or ceiling and connect a water supply source to each individual fluid discharge outlet, such as to toilets, sinks, tubs, showers, etc.

During construction of a building or home, the pipes are connected or soldered in fixed locations within the building walls. An extension known as a “stub out” is connected to the wall-mounted pipes and projects laterally from the pipes outward through a wall surface where a discharge outlet is provided to a sink, toilet, tub, etc.

Building codes require that the entire plumbing system be checked for leaks. This is accomplished by sweating or soldering test caps on each stub out at the completion of the rough plumbing stage to enable the entire plumbing system to be pressurized.

After successful completion of the pressure test, the test caps are removed from the stub outs, typically by cutting the test caps off the stub out or applying heat to melt the solder. The individual plumbing fixtures are then attached to each stub out.

The use of such test caps is time consuming which adds to the overall plumbing cost for a building or home. Although a skilled plumber can quickly solder a test cap onto a stub out and/or remove the same test cap from the stub out, the number of stub outs in a typical building or home still makes this process a time consuming and costly task.

Thus, it would be desirable to provide a new fluid connection which simplifies and reduces the cost of mounting and removing test caps on building and home plumbing systems.

Generally, fluid connectors are known which provide a quick connection between two fluidic components, such as fuel filters, manifolds, pumps, and conduits as well as the two conduits themselves.

Snap-fit or quick connectors are employed in a wide range of applications, particularly, for joining fluid carrying conduits in automotive and industrial applications. Such quick connectors utilize retainers or locking elements for securing one connector component, such as a tubular conduit, within a complimentary bore of another connector component or housing. Such retainers are typically of either the axially-displaceable or radially-displaceable type. The terms “axially displaceable” or “radially displaceable” are taken relative to the axial bore in another component.

In a typical snap-fit quick connector with an axially displaceable retainer, the retainer is mounted within a chamber in a housing of one connector component. The retainer has a plurality of radially and angularly extending legs which extend inwardly toward the axial center line of the bore in the housing. A tube or conduit to be sealingly mounted in the bore in the housing includes a radially upset portion or flange which engages an inner end of the retainer legs. Seal and spacer members as well as a top hat are typically mounted in the bore ahead of the retainer and the conduit to form a seal between the housing and the conduit when the conduit is lockingly engaged with the retainer legs in the housing.

Radially displaceable retainers are also known in which the retainer is radially displaceable through aligned bores or apertures formed transversely to the main throughbore in the housing. The radially displaceable retainer is typically provided with a pair of depending legs which are sized and positioned to slip behind the radially upset portion or flange on the conduit only when the conduit is fully seated in the bore in the housing. This ensures a positive locking engagement of the with the housing as well as providing an indication that the conduit is fully seated since the radially displaceable retainer can be fully inserted into the housing only when the conduit has been fully inserted into the bore in the housing.

Regardless of the type of retainer, the housing portion of a fluid connector typically includes an elongated stem having one or more spaced, annular barbs. The barbs provide secure engagement with a tube or conduit which is forced over the barbs to connect the housing with one end of the conduit.

Although such quick connectors are reliable in operation, the retainers represent an additional, separate component which adds to the manufacturing cost and assembly time of the quick connector as well as requiring a final installation step to move the retainer in a case of transversely moveable retainers, from a partially inserted, stored position to a fully latched position in the connector housing.

Quick connectors are known which have the retainer integrally formed as part of the housing. The retainer elements which engage the endform, such as angularly inward extending arms or fingers, are coupled to one end of a rigid portion of the housing by flexible bears. The beams enable a ring carrying the endform engagement elements or fingers to be flexed out of engagement with the endform to separate the endform from the connector body.

Thus, it would be desirable to provide a fluid coupling having a quick connector which is constructed of a minimum number of separate components; while, at the same time, being easily mountable on a fluid component in a single continuous action. It would also be desirable to provide a fluid coupling which can be adaptable for use in many different applications, including connecting two separate fluid components in fluid communication and to attach a closed end test cap to a plumbing stub out.

### SUMMARY OF THE INVENTION

In one aspect, a fluid coupling includes a tubular endform having a bore extending from a first open end. An annular groove is formed in an exterior surface of the endform spaced from the first end. A connector body has first and second ends, with a bore extending from the first end. Initially spaced latch engagement and latch members are carried on the housing. A collapsible portion is formed in the housing between the latch engagement members and the latch members. The collapsible portion deforms radially inward into the annular groove on the endform after the endform engages the first end of the body to fixedly couple the body to the endform.

In another aspect, a test cap is provided for closing an open bore in a tubular fluidic endform having an annular groove spaced from the first open end. The test cap includes a connector body having first and second ends. A bore extends from the first end of the body. Initially spaced latch engagement and latch members are carried on the housing. A collapsible portion is formed in the housing between the latch engagement members and the latch members. The collapsible portion deforms radially inward into the annular groove on the endform after the endform engages the first end of the body to fixedly couple the body to the endform.

In yet another aspect, a fluid quick connector is attachable to a tubular fluid endform having a bore extending from a first open end and an annular groove formed in an exterior surface spaced from the first end. The fluid quick connector includes a connector body having first and second ends. A bore extends from the first ends. Initially spaced latch engagement and latch members are carried on the housing. A collapsible portion is formed in the housing between the latch engagement members and the latch members. The collapsible portion deforming radially inward into the annular groove on the endform after the endform engages the first end of the body to fixedly couple the body to the endform.

The quick connector described herein provides all of the functions of a fluid quick connector, but is formed with a minimal number of components for reduced manufacturing cost and less assembly and installation time. This results in a reliable quick connector which is versatile in application. The quick connector can act as a test cap for a building plumbing system pressurization test when the second end of the connector body is closed. Alternately, the connector body can have an open second end to establish fluid flow between the end form and a fluid component coupled to the second end of a connector body.

### BRIEF DESCRIPTION OF THE DRAWINGS

The various features, advantages and other uses of the present invention will become more apparent by referring to the following detailed description and drawing in which:

FIG. 1 is an exploded, partially longitudinally cross-sectioned view of one aspect of a fluid coupling showing a quick connector in a non-assembled state;

FIG. 2 is a partially longitudinally cross-sectioned, view showing the quick connector of FIG. 1 partially engaged with an endform;

FIG. 3 is a partial longitudinally cross-sectioned view, similar to FIG. 1, but showing the quick connector in a fully engaged position on the endform;

FIG. 4 is a perspective view of the quick connector shown in the fully engaged position on the endform;

FIG. 5 is a partially longitudinally cross-sectioned view, similar to FIG. 4, but showing another aspect of the quick connector; and

FIG. 6 is a partially longitudinally cross-sectioned view showing another aspect the fluid coupling in which the quick connector is fluidically coupled to a flexible conduit.

### DETAILED DESCRIPTION OF THE DRAWINGS

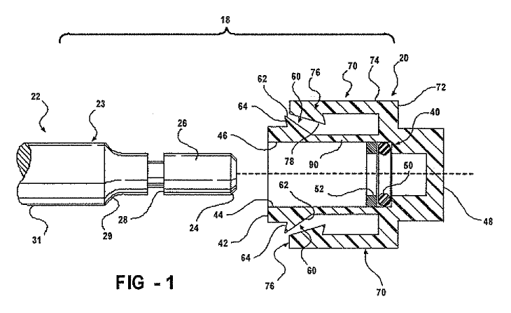

Referring to FIGS. 1-4 of the drawing, there is disclosed one aspect of fluid coupling 18 including a plumbing test cap 20 temporarily fixed mounted over an end of a stub out 22 projecting laterally outward from a building or home plumbing system, not shown.

By way of example only, the stub out 22 is typically in the form of a tubular member, such as a pipe. An end form profile 23 on the stub out 22 includes a tip portion 26 with a tip end 24. A surface engagement feature 28 is formed in the endform 23 at a position spaced from the tip end 24. Although the surface engagement feature 28, in one example, is depicted as being an annular recess or groove formed in the end form 23, it will be understood that the surface engagement feature 28 may also be a raised bead or flange projecting radially outward from the exterior surface of the end form 23.

A bore 30 is formed in the stub out 22 and extends from the end of the stub out 22 connected to the building plumbing system, not shown, to an opening 32 in the tip end 24.

By way of example only, a transition surface 29 is formed in the endform 23 between the surface engagement feature 28 and an adjacent large diameter portion 31 of the endform 23. The transition surface 29 can be formed with a step-like flat wall, a smoothly curved radius, or an arcuate shape as shown by example in FIG. 1.

The fluid coupling 18 includes a housing or body 40 typically formed of a one-piece, molded or formed plastic. The body 40 is formed of generally rigid material, such as a polymeric material.

The body 40 includes a first end 42 having an aperture 44 formed therein fluidically opening to a bore 46 extending from the first end 42 to an opposed second end 48. Although in certain applications, the body 40 could be designed for fluid flow completely through the aperture 44 in the first end 42 through an aperture in the second end 48, the body 40 shown in FIGS. 1-4 has the second end 48 closed to enable use of the body 40 as a test cap for a building or home plumbing system pressure test.

Seal members 50 and 52 disposed in the bore 46 of the body 40 sealingly engage the exterior surface of the end form 23 when the body 40 is mounted over the tip portion 26 of the end form 23 on the stub out 22 to sealingly couple the body 40 to the stub out 22. The seal members may include a resilient O-ring 50, and a rigid ringer, or spacer 52 which is press fit in the bore 46.

The body 40 has a generally constant outer diameter over a portion of its overall length between the first and second ends 42 and 48. At least one or more latch members, with two latch members 60 and 62 shown by way of example only and spaced 180° apart about the circumference of the body 40 are formed in the body 40 and project radially outward from a position spaced from the first end 42. Each projection 60 has a leading surface 62, such as an inclined ramp, which extends radially outward in increasing thickness toward the first end 42.

A latch engagement surface 64 is formed on one end of each projection 60. The latch engagement surface 64 may be either flat or arcuate and may be perpendicular to the exterior surface of the body 40 or disposed at an acute angle as shown by example only in FIG. 1.

The one or more projections 60 can be replaced by a continuous 360° annular projection having the same cross-section shape as each individual projection 60 described above and shown in FIG. 1.

One latch engagement member 70 is provided on the body 40 for each discrete latch member 60, for example. Each latch engagement member 70 includes a stem 72 which projects radially outward from the body 40, and a flexible or bendable arm 74 which extends substantially concentric with the exterior surface of the body 40 from the stem 72 toward the first end 42. A hook or projection 76 extends radially inward from one end of each arm 74. The hook 76 includes a ramp surface which engages and slides along the ramp surface 62 on the corresponding projection 60, and an engagement surface 80 which is adapted to lockingly engage the latch engagement surface 64 on each projection 60.

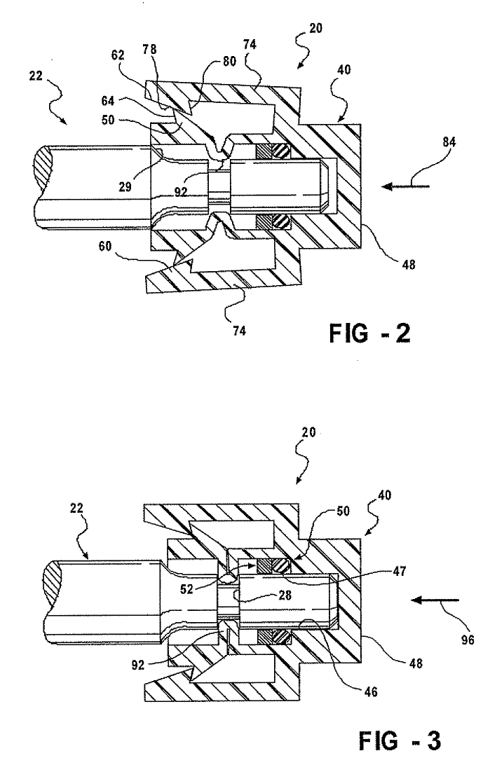

Referring back to FIG. 1, the body 40 of the quick connector 20 includes a collapsible or deformable portion 90 which is disposed intermediately between the one or more projections 60 and the remaining portion of the body 40 extending to the second end 48. The collapsible portion 90 has a thickness less than the overall thickness of the sidewall of the body 40 so as to be able to deform or collapse radially inward to form an annular bulge or enlargement 92 as shown in FIGS. 2 and 3, filling the surface engagement feature or groove 28 on the endform 22 to fixably latch the quick connector 20 on the endform 22. Formation of the enlargement 92 also causes the projection(s) 60 and the hooks 76 on the arms 74 to move closer together into engagement.

As shown in FIG. 1, in a normal position, prior to engagement of the quick connector 20 with the endform 22, the collapsible portion 90 is extended concentrically with the longitudinal axis of the body 40. During initial engagement on the body 40 and the endform 23, the first end 42 of the body 40 engages the transition surface 29 on the endform 22 stopping further axial movement of the first end 42 relative to the endform 22. However, further insertion force in the direction of arrow 84 in FIG. 2 on the second end 48 of the body 40, causes the thin-walled, collapsible portion 90 to radially deform inward to form the initial stage of the radially inward extending bulge or projection 92 shown in FIG. 2. The initial stage of the bulge formation shown in FIG. 2 occurs substantially simultaneously with sliding engagement of the ramp surfaces 62 and 78 on the quick connector body 40.

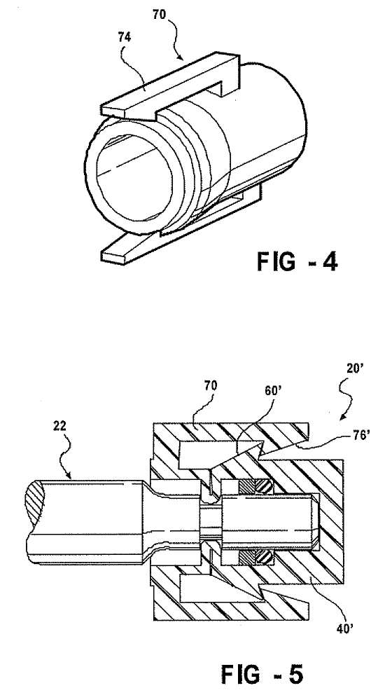

During the initial engagement of the body 40 with the tip end 26 of the endform 22, such as by movement of the body 40 in the direction of arrow 84 in FIG. 2 over a stationary endform 22, the ramp surfaces 62 and 78 engage as shown in FIG. 2. This causes flexing of each arm 74 to move the free end of the arm 74 in a radially outward direction until, as shown in FIGS. 3 and 4, the edge of the latch engagement surface 80 on the arm 74 clears the end on the arm 74 of the ramp 62 on the projection 60. At this time, the end of arm 74 snaps back to its original or normal position as shown in FIGS. 1 and 3 bringing the latch engagement surface 80 into fixed and locked engagement with the corresponding latch surface 64 to fix the connector body 40 on the tip end 26 of the endform 22.

Continued insertion force in the direction of arrow 96 in FIG. 3, causes the latch engagement surface 80 to lock to the engagement surface 64 and the projection 92 completely fills the engagement surface 80 or groove 28 on the endform 22 projection to mechanically fix the quick connector 20 on the endform 22.

In order to remove the quick connector 20 from the endform 22, it is necessary to disengage the latch engagement member(s) 70 from one or more projections 60 and then forcibly disengage the projection 92 from the groove 28.

In the fixed or latched position shown in FIGS. 3 and 4, due to the closed second end 48 on the body 40, the quick connector 20 can function as a test cap during a pressurization test of a water supply system in a building or house.

Another aspect of a quick connector 20′ is shown in FIG. 5. The quick connector 20′ functions in the same manner as the quick connector 20 insofar as being able to be able to be fixably latched on the end form 22 as described above. However, in the quick connector 20′, the angular direction of the mating ramp surfaces 62 and 78 on one or more projections 60 and the arms 70 is reversed. The one or more projections 60 and the hooks 76′ on the ends of the latch arms 70 function in the same manner to axially fix the overall length of the collapsed body 40 in the position shown in FIG. 5, wherein the quick connector 20′ is fixedly latched on the endform 23.

In the fixedly latched position of the body 40 or 40′ and the endform 23, the one or more seal elements 50 and 52, as shown in FIGS. 3 and 5, are disposed in the bore 46 in the body 40 or 40′ collapsed or dimensionally shortened between an internal shoulder 47 formed between two different diameter portions of the bore 46 and the bulge or projection 92 and the collapsed body 40 to sealingly couple the quick connector 20 and the endform 23.

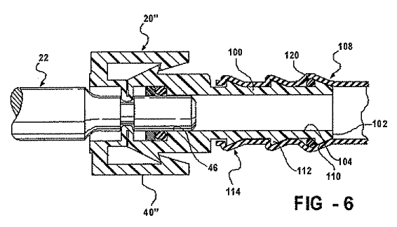

Referring to another aspect shown in FIG. 6, a modified quick connector 20′ mounted on the endform 22 as described above is used. However, it will be understood that the first described quick connector 20 could also be employed.

In this aspect, the closed second end 48 of the connectors 20 and 20′, as shown in FIGS. 1 and 5, is replaced by an elongated stem 100 on the quick connector 20″ which terminates in an open end 102. A bore 104 is formed within the stem 100 coaxial with the bore 46 in the body 40″ to establish a fluid flow path from the endform 23 to a second fluid component 108 which, by example only, is illustrated and hereafter described as being a flexible, expandable conduit.

The stem 102 includes conduit retention surfaces in the form of one or more barbs or radially outward extending ramp surfaces 110, 112 and 114, with three barbs 10, 112 and 114 being described and illustrated by example only. The endmost barb 110 contiguous with the end 102 of the stem 100 may be formed with a radially larger dimension than the remaining barbs 112 and 114 so as to expand the open end of the conduit 108 outward over the end 102 of the stem 100. A seal element, such as an O-ring 120, may be mounted on the stem 100 adjacent to an axially inner end of the first barb 110, either on the exterior surface of the stem 100 or in a shallow annular groove formed in the stem 100 adjacent to the endwall portion of the barb 110

In summary, there has been disclosed a unique fluid quick connector which contains a minimal number of separate components for a low manufacturing cost and reduced assembly and installation time, while at the same time provides reliable and easy attachment to an endform. The quick connector is usable in many different applications, such as a plumbing system pressurization test cap where the quick connector has a closed second end or as a flow through connector connecting two fluidic elements such as conduits, etc.

What is claimed is:

1. A fluid coupling comprising:
an endform having a bore extending from a first open end;
an annular groove formed in an exterior surface of the endform spaced from the first end;
a connector body having first and second ends, a bore extending from the first end;
at least one latch engagement member and at least one latch member carried on the housing and initially spaced apart; and
a collapsible portion formed in the housing between the latch engagement member and the latch member, the collapsible portion deforming radially inward, after the first end of the body fixedly engages the endform, into the groove on the endform to fixedly couple the body to the endform.

2. The fluid coupling of claim 1 further comprising:
a seal element disposed between the endform and an inner surface defining the bore in the body to sealingly couple the endform to the body.

3. The fluid coupling of claim 2 wherein:
the seal is carried in the bore in the body.

4. The fluid coupling of claim 1 wherein:
the second end of the body is closed to fluid flow.

5. The fluid coupling of claim 1 wherein:
the second end of the body is open to fluid flow.

6. The fluid coupling of claim 1 wherein, the latch engagement member and the latch member include opposed latch surfaces.

7. The fluid coupling of claim 6 wherein:
the opposed latch surfaces comprise complementary hooks.

8. The fluid coupling of claim 6 wherein:
at least one of the latch member and the latch engagement member includes a ramp surface.

9. The fluid coupling of claim 1 wherein:
the at least one latch engagement member includes at least two circumferentially spaced latch engagement members.

10. The fluid coupling of claim 1 wherein the latch engagement member comprises:
a hook carried on an arm flexibly coupled to the body.

11. The fluid coupling of claim 1 wherein the latch member comprises:
at least one radially outward extending hook.

12. The fluid coupling of claim 1 wherein:
the body, the latch member and the latch engagement member are unitarily formed of a one-piece, molded structure.

13. The fluid coupling of claim 1 wherein the collapsible portion comprises:
an annular, thin-walled portion carried on the body between and nominally spacing the latch member and the latch engagement member.

14. A test cap for closing an open end of a bore in a fluid endform having an annular groove spaced from the first open end, the test cap comprising:
a connector body having first and second ends, a bore extending from the first end;
at least one latch engagement and at least one latch member carried on the housing and initially spaced apart; and
a collapsible portion formed in the housing between the latch engagement member and the latch member, the collapsible portion deforming radially inward, after the first end of the body fixedly engages the endform, into the annular groove on the endform to fixedly couple the body to the endform.

15. The test cap of claim 14 further comprising:
a seal element disposed between the endform and an inner surface defining the bore in the body to sealingly couple the endform to the body.

16. The test cap of claim 15 wherein:
the seal is carried in the bore in the body.

17. The test cap of claim 14 wherein:
the second end of the body is closed to fluid flow.

18. The test cap of claim 14 wherein:
the latch engagement member and the latch member include opposed latch surfaces.

19. The test cap of claim 18 wherein:
the opposed latch surfaces comprise complementary hooks.

20. The test cap of claim 18 wherein:
at least one of the latch member and the latch engagement member includes a ramp surface.

21. The test cap of claim 14 wherein:
the at least one latch engagement member includes at least two circumferentially spaced latch engagement members.

22. The test cap of claim 14 wherein the latch engagement member comprises:
a hook carried on an arm flexibly coupled to the body.

23. The test cap of claim 14 wherein the latch member comprises:
at least one radially outward extending hook.

24. The test cap of claim 14 wherein:
the body, the latch member and the latch engagement member are unitarily formed of a one-piece, molded structure.

25. The fluid coupling of claim 14 wherein the collapsible portion comprises:
an annular, thin-walled portion carried on the body between and nominally spacing the latch member and the latch engagement member.

26. A fluid connector for attachment to a fluid endform having a bore extending from an open end and an annular groove formed in an exterior surface spaced from the end, the fluid connector comprising:
a connector body having first and second ends, a bore extending from the first end;
at least one latch engagement member and at least one latch member carried on the housing and initially spaced apart; and
a collapsible portion formed in the housing between the latch engagement member and the latch member, the collapsible portion deforming radially inward, after the first end of the body fixedly engages the endform, into the annular groove on the endform to fixedly couple the body to the endform.

27. The fluid connector of claim 26 further comprising:
a seal element disposed between the endform and an inner surface defining the bore in the body to sealingly couple the endform to the body.

28. The fluid connector of claim 27 wherein:
the seal is carried in the bore in the body.

29. The fluid connector of claim 26 wherein:
the second end of the body is open to fluid flow.

30. The fluid connector of claim 26 wherein:
the latch engagement member and the latch member include opposed latch surfaces.

31. The fluid connector of claim 30 wherein:
the opposed latch surfaces comprise complementary hooks.

32. The fluid connector of claim 30 wherein:
at least one of the latch member and the latch engagement member includes a ramp surface.

33. The fluid connector of claim 26 wherein:
the at least one latch engagement member includes at least two circumferentially spaced latch engagement members.

34. The fluid connector of claim 26 wherein the latch engagement member comprises:
a hook carried on an arm flexibly coupled to the body.

35. The fluid connector of claim 27 wherein the latch member comprises:
at least one radially outward extending book.

36. The fluid connector of claim 26 wherein:
the body, the latch member and the latch engagement member are unitarily formed of a one-piece, molded structure.

37. The fluid connector of claim 26 wherein the collapsible portion comprises:
an annular, thin-walled portion carried on the body between and nominally spacing the latch member and the latch engagement member.
